(19) United States
(12) Patent Application Publication
(10) Pub. No.: US 2025/0292917 A1
(43) Pub. Date: Sep. 18, 2025

(54) HELICAL FUSION REACTOR, VACUUM VESSEL OF HELICAL FUSION REACTOR, AND METHOD FOR MAINTAINING HELICAL FUSION REACTOR

(71) Applicant: Helical Fusion Co., Ltd., Tokyo (JP)

(72) Inventors: Junichi MIYAZAWA, Tajimi-shi (JP); Takuya GOTO, Nagoya-shi (JP)

(21) Appl. No.: 19/078,305

(22) Filed: Mar. 13, 2025

(30) Foreign Application Priority Data
Mar. 15, 2024 (JP) 2024-041707

(51) Int. Cl. G21B 1/13; G21B 1/05; G21B 1/17; G21B 1/25

(52) U.S. Cl. CPC G21B 1/13; G21B 1/05; G21B 1/17; G21B 1/25

(57) ABSTRACT

A blanket 50 includes a plurality of module assemblies 50A disposed in a circumferential direction Dr around a vertical center line C1 of a helical coil 30. Each of the plurality of module assemblies 50A includes a plurality of blanket modules 51. Each blanket module 51 is movable upward from a gap A formed in the helical coil 30. A vacuum vessel 20 includes a movable cover 21 that covers an upper side of the helical coil 30 and the 10 plurality of module assemblies 50A and is openable and closable. The movable cover 21 is configured such that the whole movable cover 21 moves integrally when the movable cover 21 is opened and closed. Such a structure enables the blanket to be maintained and replaced more efficiently.

### CROSS-REFERENCE TO RELATED APPLICATION

The present application claims priority from Japanese application No. 2024-041707 filed on Mar. 15, 2024, the content of which is hereby incorporated by reference into this application.

### BACKGROUND OF THE INVENTION

### 1. Field of the Invention

The present disclosure relates to a helical fusion reactor, a vacuum vessel of the helical fusion reactor, and a method for maintaining the helical fusion reactor.

### 2. Description of the Related Art

A helical fusion reactor includes helical coils formed of superconducting wires, a cryostat for thermally insulating the helical coils, and a blanket disposed inside the helical coils, for example. The blanket has the functions of breeding tritium, shielding radiation, and converting kinetic energy of neutrons into thermal energy, for example. The radiation and particles from the plasma are incident on the blanket and degrade the material of the blanket. As such, the blanket needs to be regularly maintained and replaced. Non-patent literature “J. Miyazawa, T. Goto, Y. Hamaji and M. I. Kobayashi, “Coordinated design of the cartridge-type blanket and the ceramic pebble divertor for the helical reactor FFHR-b3”, Nuclear Fusion, International Atomic Energy Agency, 18th November 2021, 61, 126062 (2021)”proposes a blanket composed of a plurality of modules (blanket modules). The blanket modules are combined with each other to form a single module assembly. The multiple module assemblies are disposed around the center line along the vertical direction of the fusion reactor to form an annular blanket.

The helical coil and the blanket are disposed in a vacuum vessel. For the maintenance and replacement of the blanket, it is required that the blanket module is removed from the vacuum vessel and a new blanket module is transported inside the vacuum vessel. The efficiency of the maintenance operation is important so as to provide a commercial fusion reactor.

### SUMMARY OF THE INVENTION

An example of a helical fusion reactor proposed in the present disclosure includes a helical coil, a blanket that is at least partially disposed inside the helical coil, and a vacuum vessel that houses the helical coil and the blanket. The blanket includes a plurality assemblies disposed in a circumferential direction around a center line along a vertical direction of the helical coil. Each of the plurality of module assemblies including a plurality of blanket modules. Each blanket module is movable upward from a gap formed in the helical coil. The vacuum vessel includes a movable cover that covers an upper side of the helical coil and the plurality of module assemblies and is openable and closable. The movable cover is configured such that the whole movable cover moves integrally when the movable cover is opened and closed.

An example of a helical fusion reactor proposed in the present disclosure includes a helical coil, a blanket that is at least partially disposed inside the helical coil, and a vacuum vessel that houses the helical coil and the blanket. The helical coil includes a first coil upper-half, a second coil upper-half, and a third coil upper-half that are disposed in a circumferential direction around a center line along a vertical direction of the helical coil and positioned above a horizontal plane passing through the center of the helical coil. The blanket includes a plurality of module assemblies disposed in the circumferential direction. Each of the plurality of module assemblies includes a plurality of blanket modules. The plurality of module assemblies include a first module assembly and a second module assembly. The first module assembly is positioned between the first coil upper-half and the second coil upper-half in a plan view of the helical coil. The second module assembly is positioned between the second coil upper-half and the third coil upper-half in a plan view of the helical coil. The vacuum vessel includes a movable cover that covers an upper side of at least the first module assembly and the second module assembly and is openable and closable. The movable cover is configured such that the whole movable cover moves integrally when the movable cover is opened and closed. In this structure, the vacuum vessel may include a plurality of movable covers, and the plurality of movable covers may cover the entire helical coil and the plurality of module assemblies.

An example of the vacuum vessel proposed in the present disclosure is for housing a helical coil and a blanket of the helical fusion reactor. At least part of the blanket is disposed inside a helical coil. The blanket includes a plurality of module assemblies disposed in a circumferential direction around a center line along a vertical direction of the helical coil. Each of the plurality of module assemblies includes a plurality of blanket modules, and each blanket module is movable upward from a gap formed in the helical coil. The vacuum vessel includes a movable cover that covers an upper side of the helical coil and the plurality of module assemblies and is openable and closable. The movable cover is configured such that the whole movable cover moves integrally when the movable cover is opened and closed.

An example of the vacuum vessel proposed in the present disclosure for housing a helical coil and a blanket of the helical fusion reactor. At least part of the blanket is disposed inside a helical coil. The helical coil includes a first coil upper-half, a second coil upper-half, and a third coil upper-half that are disposed in a circumferential direction around a center line along a vertical direction of the helical coil and positioned above a horizontal plane passing through the center of the helical coil. The blanket includes a plurality of module assemblies disposed in the circumferential direction. Each of the plurality of module assemblies includes a plurality of blanket modules. The plurality of module assemblies include a first module assembly and a second module assembly. The first module assembly is positioned between the first coil upper-half and the second coil upper-half in a plan view of the helical coil. The second module assembly is positioned between the second coil upper-half and the third coil upper-half in a plan view of the helical coil. The vacuum vessel includes a movable cover that covers an upper side of at least the first module assembly and the second module assembly and is openable and closable. The movable cover is configured such that the whole movable cover moves integrally when the movable cover is opened and closed. In this structure, the vacuum vessel may include a plurality of movable covers, and the entire helical coil and the plurality of module assemblies may be covered by the plurality of movable covers.

The maintenance method proposed in the present disclosure is a method for maintaining a helical fusion reactor including a helical coil and a blanket, at least part of the blanket being disposed inside a helical coil, the helical coil and the blanket being housed in a vacuum vessel, the vacuum vessel including a movable cover that covers an upper side of the helical coil, and an outer peripheral edge of the movable cover being joined to a part of the vacuum vessel other than the movable cover. The method includes moving a release device along the outer peripheral edge of the movable cover to release a joint between the outer peripheral edge of the movable cover and the part of the vacuum vessel, opening the movable cover, and pulling up a blanket module constituting the blanket from a gap formed in the helical coil by using a transport system.

According to the helical fusion reactor, the vacuum vessel of the helical fusion reactor, and the method for maintaining the helical fusion reactor described above, the maintenance and replacement of the blanket can be more efficiently performed compared to a structure where one movable cover is provided for each module assembly.

### BRIEF DESCRIPTION OF THE DRAWINGS

FIG. 1 is a perspective view of an example of a helical fusion reactor proposed in the present disclosure;

FIG. 2 is a perspective view of an inside of a bioshield of the fusion reactor, half of the bioshield being removed;

FIG. 3 is a perspective view of a vacuum vessel shown in FIG. 2 being viewed from the lower side obliquely;

FIG. 4 is a perspective view of a movable cover of the vacuum vessel being open;

FIG. 5 is an exploded perspective view of the vacuum vessel and a reactor main body M housed therein;

FIG. 6A is a plan view of the vacuum vessel; FIG. 6B is a perspective view of a main part of the vacuum vessel;

FIG. 7A is a perspective view of a part of the reactor main body;

FIG. 7B is a perspective view of an opposite side of the reactor main body shown in FIG. 7A;

FIG. 8 is a perspective view of a module assembly separated from a cryostat;

FIG. 9A is a perspective view of a helical coil and a module assembly combined together with the cryostat being omitted;

FIG. 9B is a perspective view of an opposite side of the part shown in FIG. 9A;

FIG. 10A is a plan view of a part of a helical coil;

FIG. 10B is a plan view of a part of a helical coil;

FIG. 10C is a view of the part shown in FIG. 10A viewed horizontally;

FIG. 11 is an exploded perspective view of an upper pool, a module assembly, and a lower pool;

FIG. 12 is an exploded perspective view of the module assembly;

FIG. 13A is a plan view of two adjacent module assemblies;

FIG. 13B is a perspective view of the lower side of the module assembly;

FIG. 14 is a cross-sectional view of the module assembly and the helical coil taken along the line XIV-XIV shown in FIG. 13A;

FIG. 15A is a perspective view of some of the blanket modules constituting the module assembly;

FIG. 15B is a perspective view of the two blanket modules shown in FIG. 15A combined together;

FIG. 16 is a perspective view of some of the blanket modules constituting the module assembly;

FIG. 17 is a perspective view of a sliding mechanism of the blanket module provided on a top wall of the cryostat; and

FIG. 18 is a flow chart of a method for maintaining the fusion reactor.

### DETAILED DESCRIPTION OF THE INVENTION

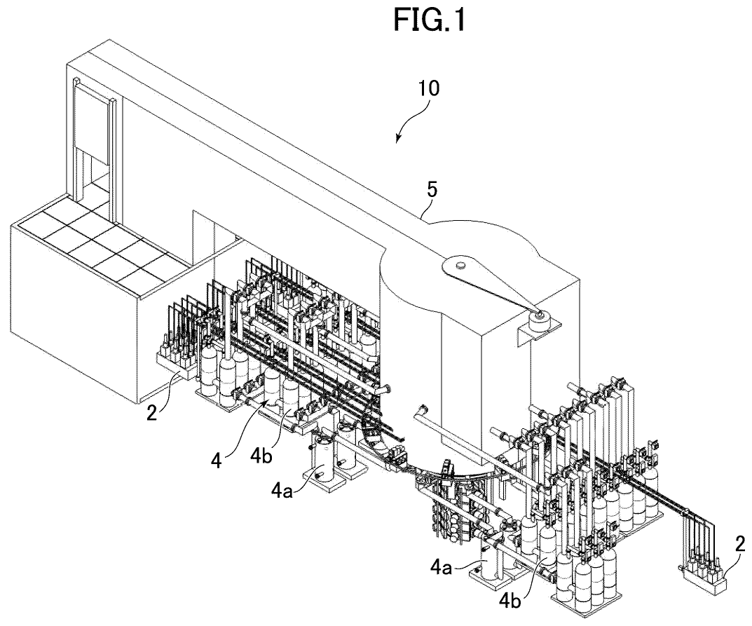

In the following, a helical fusion reactor, a vacuum vessel of the helical fusion reactor, and a method for maintaining the helical fusion reactor proposed in the present disclosure will be described. In the present specification, a helical fusion reactor 10 shown in FIG. 1 will be described as an example of the helical fusion reactor proposed in the present disclosure.

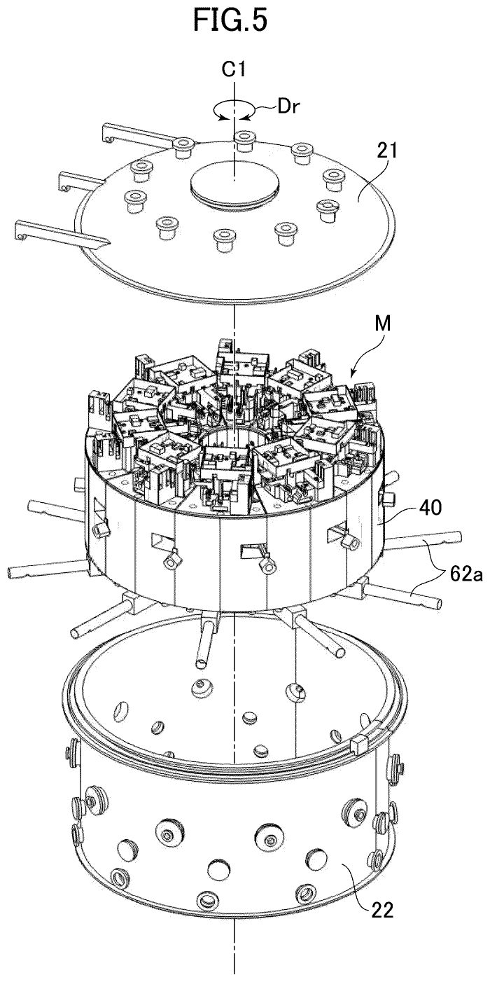

A reactor main body M housed in a vacuum vessel 20 (see FIG. 5) includes a helical coil 30. A line C1 shown in FIG. 5 is the center line along the vertical direction of the helical coil 30 and is referred to as a “vertical center line” in the following description. In FIG. 5, the direction indicated by an arrow Dr is a circumferential direction around the vertical center line C1 and is referred to as a “circumferential direction of the reactor main body.”

### Fusion Reactor

As shown in FIG. 1, the helical fusion reactor 10 includes the vacuum vessel 20 described above, a plurality of plasma heating systems 2, a fuel circulation system 3, a liquid breeding material circulation system 4, and a bioshield 5. The helical fusion reactor 10 may be installed on land or mounted on a ship.

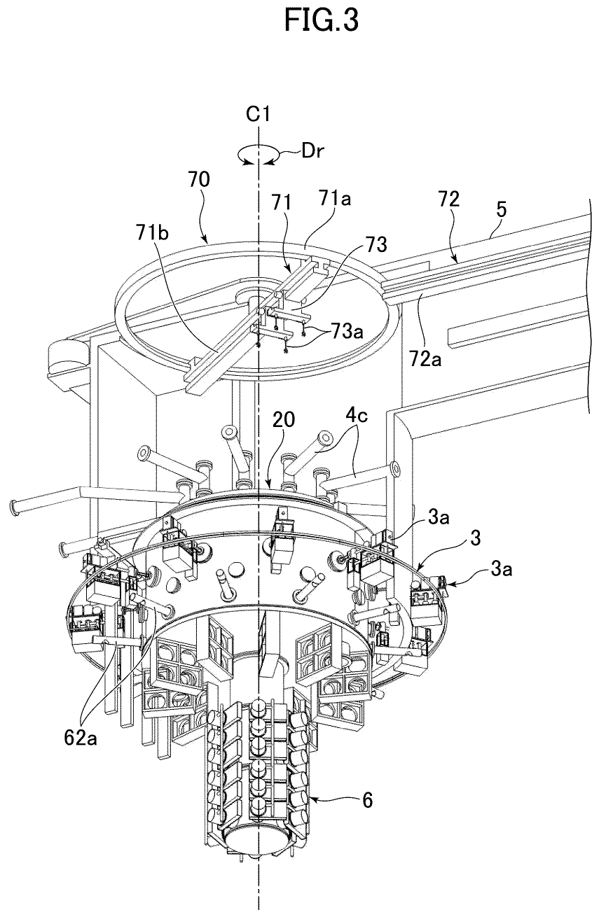

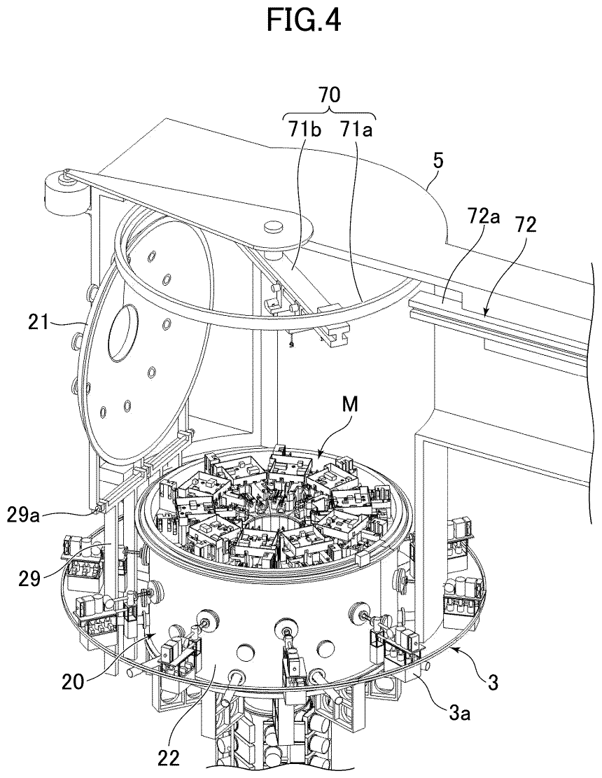

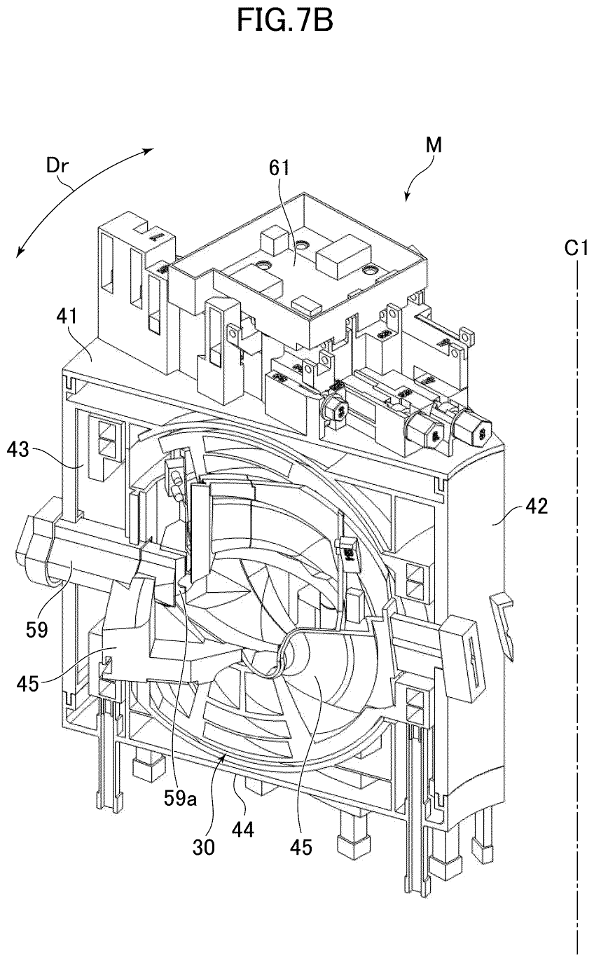

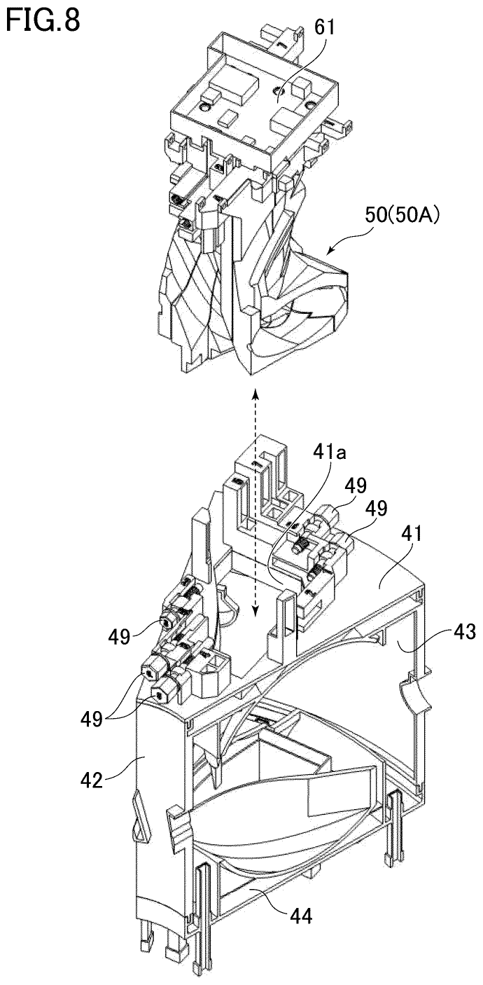

The fusion reactor main body M (see FIG. 4) including a helical coil 30 and a blanket 50 to be described later is disposed inside the vacuum vessel 20. As shown in FIG. 3, a plurality of vacuum pumps 6 are connected to the lower part of the vacuum vessel 20. The vacuum pumps 6 are cryopumps, for example, but are not necessarily limited thereto. As shown in FIG. 4, the vacuum vessel 20 includes a movable cover 21 and a cylindrical outer peripheral wall 22. The movable cover 21 can be opened and closed for the maintenance operation of the blanket 50 (see FIG. 8) constituting the reactor main body M, for example. The structure of the vacuum vessel 20 will be described in detail later.

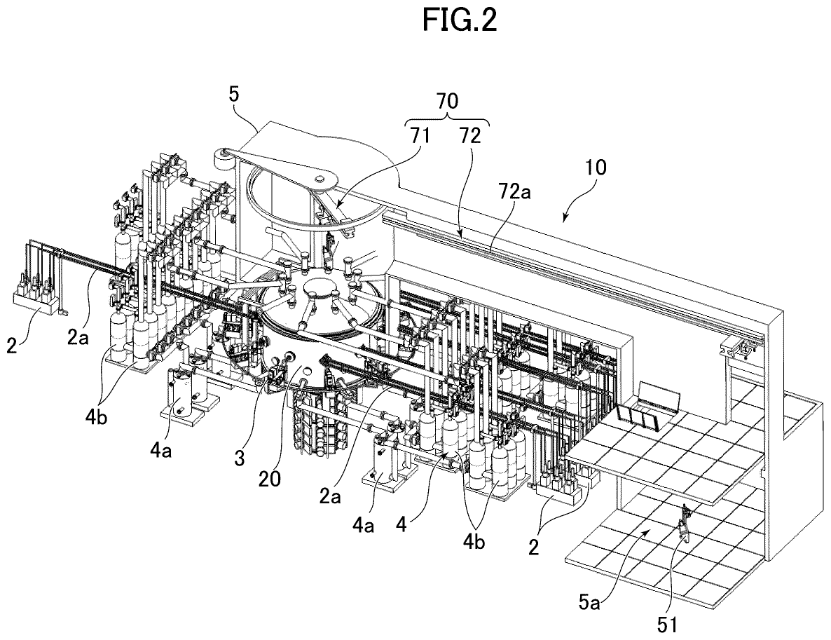

The plasma heating system 2 is for heating plasma, and may be a radio frequency heating system and a neutral particle injection system, for example. An electron cyclotron heating (ECH) system may be used as the radio frequency heating system, but other types of heating systems may also be used. As shown in FIG. 2, the plasma heating system 2 includes a plurality of pipes 2a. The pipes 2a may be connected to the outer peripheral wall 22 of the vacuum vessel 20.

The fuel circulation system 3 supplies the fuel for the fusion reaction to the reactor main body M. The fuels are mainly tritium and deuterium. The fuel circulation system 3 injects the reactor main body M as solidified pellets (hydrogen pellets), for example. The fuel circulation system 3 purifies and compresses the gas generated in the blanket 50 (more specifically, the gas generated from the liquid breeding material described later) to solidify, and injects the gas into the reactor main body M again as fuel. As shown in FIG. 2, the fuel circulation system 3 includes a plurality of injectors 3a disposed around the vacuum vessel 20. The injectors 3a may be connected to the outer peripheral wall 22 of the vacuum vessel 20.

The helical fusion reactor 10 utilizes liquid metal for breeding tritium and cooling the blanket 50. Examples of the liquid metal include, but are not limited to, liquid lithium, a tin-lead-lithium alloy, and a lithium-lead alloy. The liquid breeding material circulation system 4 supplies liquid metal (liquid breeding material) to the upper side of the blanket 50 of the reactor main body M.

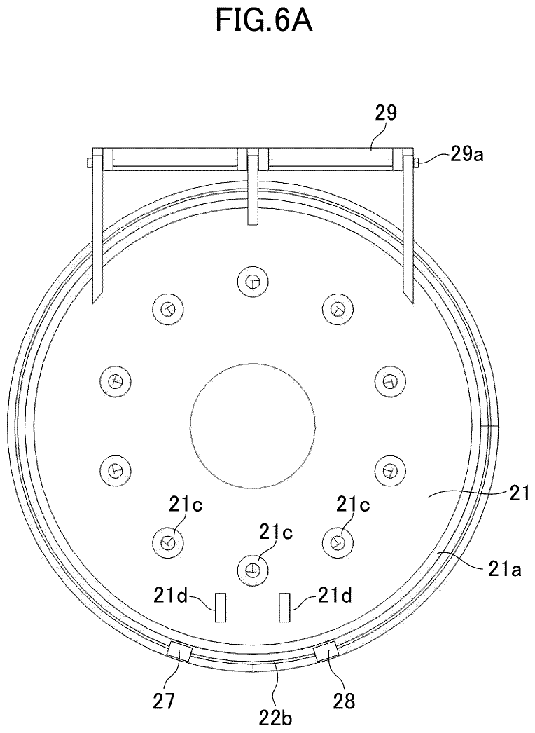

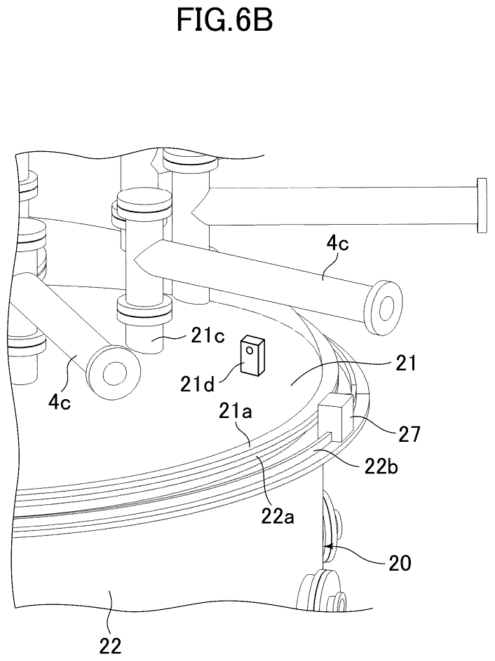

The liquid breeding material circulation system 4 recovers, from the lower side of the blanket 50, the liquid breeding material passed through the blanket 50 and passes the recovered liquid breeding material through a heat exchanger 4a (see FIG. 2) and a tritium recovery device 4b (see FIG. 2). Subsequently, the liquid breeding material circulation system 4 supplies the liquid breeding material to the blanket 50 again. The liquid breeding material circulation system 4 has a plurality of feed pipes 4c (see FIG. 6B). The feed pipes 4c are connected to the movable cover 21 of the vacuum vessel 20.

As shown in FIG. 2, the vacuum vessel 20 and the reactor main body M are disposed in the bioshield 5 for shielding radiation, for example. The bioshield 5 includes a storage chamber 5a for storing the blanket module 51 retrieved from the reactor main body M. A transport system 70 for the blanket module 51 is installed in the bioshield 5. The transport system 70 removes the blanket module 51 from the fusion reactor main body M and transports the blanket module 51 to the storage chamber 5a. The transport system 70 will also be described in detail below.

### Fusion Reactor Main Body

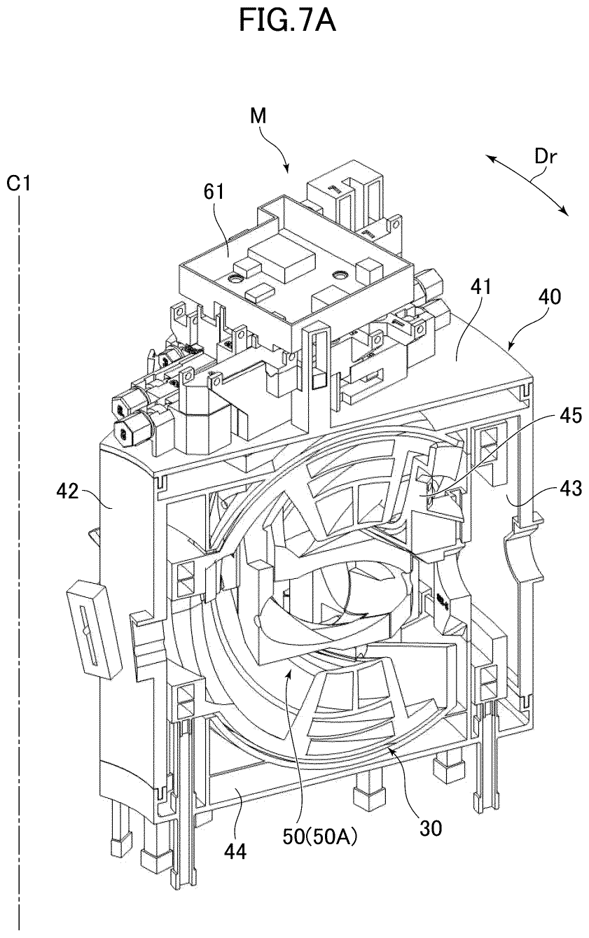

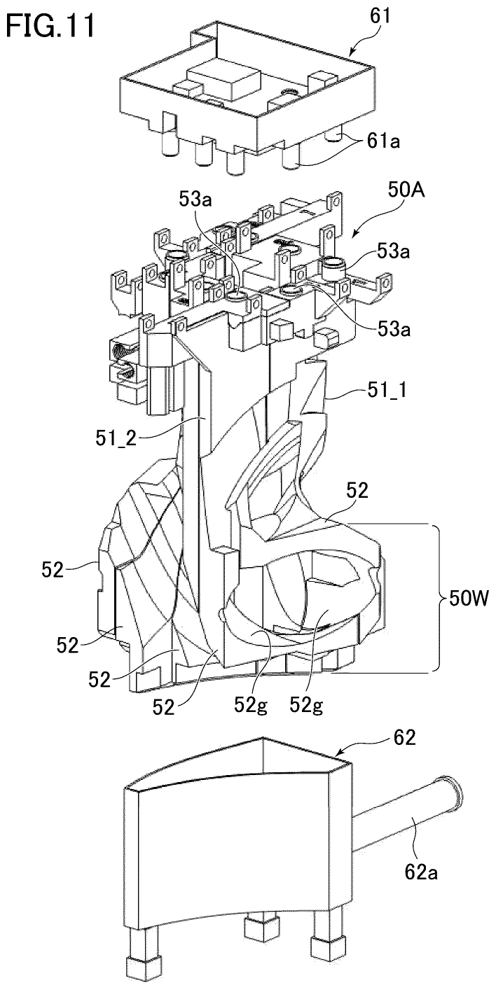

As shown in FIG. 7A, the fusion reactor main body M includes the helical coils 30, a cryostat 40, and a breeding blanket 50. The fusion reactor main body M also includes an upper pool 61 and a lower pool 62 (see FIG. 11). FIG. 7A shows only a part of the breeding blanket 50 (50A). The parts shown in FIG. 7A are arranged in the circumferential direction Dr of the reactor main body M and form the annular breeding blanket 50.

### Helical Coil

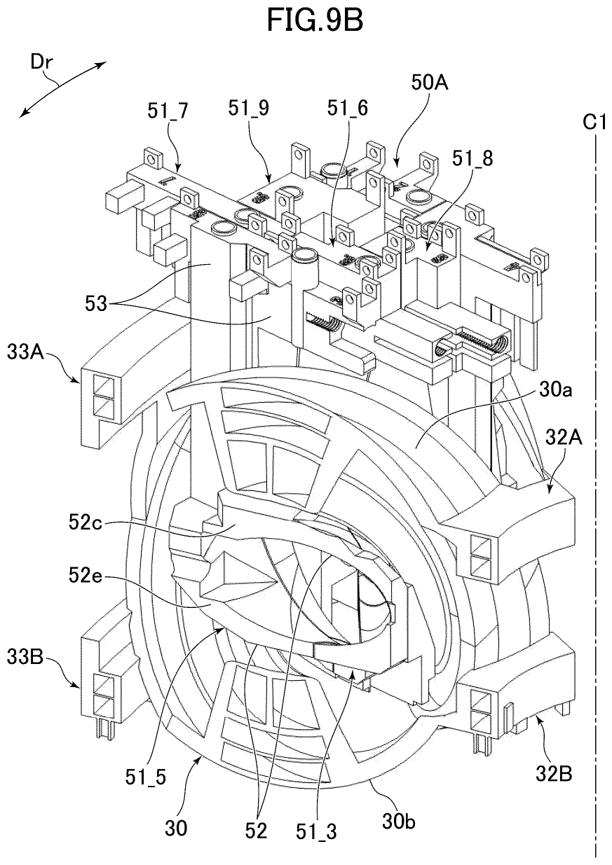

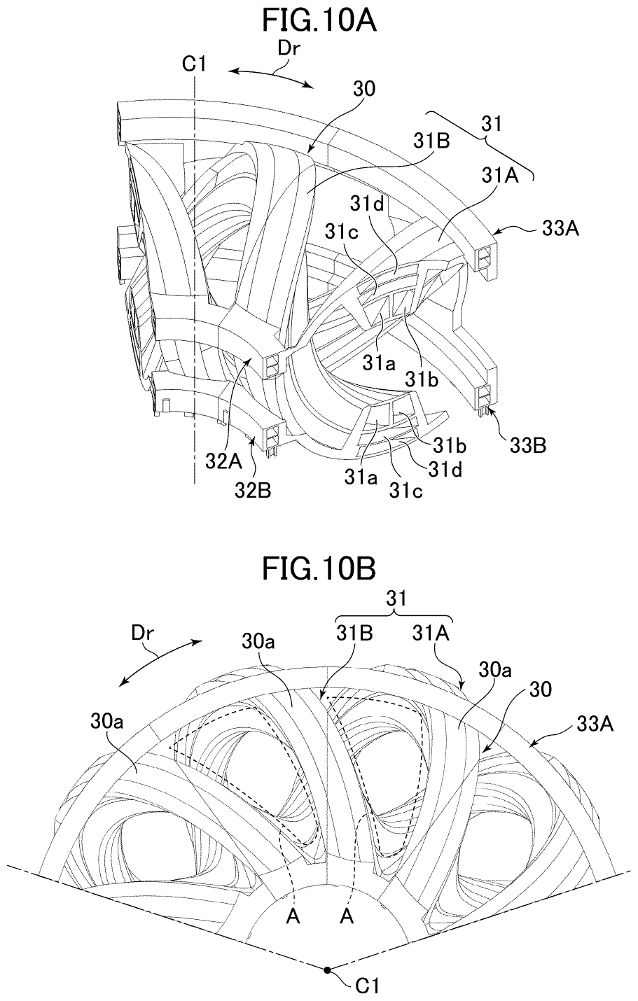

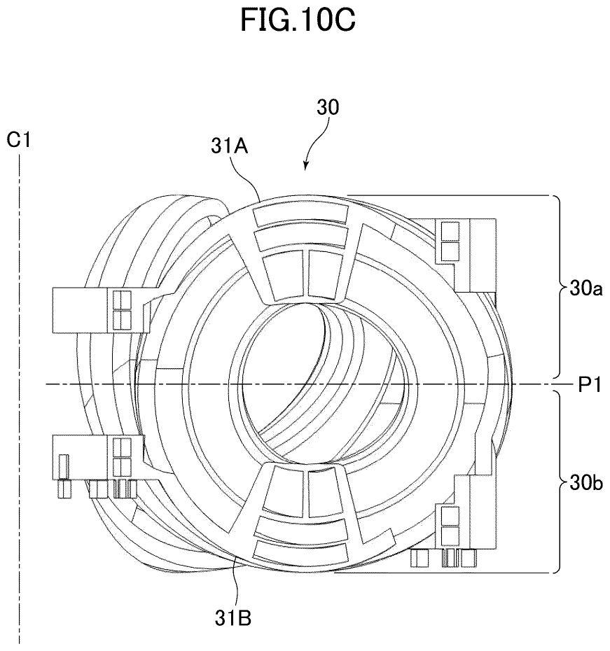

As shown in FIG. 10A, the helical coils 30 have coil supports 31. The coil support 31 has a double helix shape. That is, the coil support 31 includes two coil housings 31A and 31B formed along the surface of the torus surrounding the vertical center line C1. For example, each of the coil housings 31A and 31B has a plurality of hollow pipes 31a to 31d formed therein. Each of the hollow pipes 31a to 31d houses a superconducting wire (not shown) and a cooling pipe (not shown) which is a flow path of the coolant. The coolant can be, for example, liquid helium, liquid hydrogen, and liquid nitrogen.

The structure of the coil housings 31A and 31B is not limited to the examples described herein. For example, the helical coil 30 may not include a cooling pipe. In this case, the hollow pipes 31a to 31d may be filled with the coolant. In the example shown in FIG. 10A, four hollow pipes 31a to 31d are formed in each of the coil housings 31A and 31B, although the number of hollow pipes may be less than three or more than three.

As shown in FIG. 10A, the reactor main body M includes annular vertical magnetic field coils 32A, 32B, 33A, and 33B centered on the vertical center line C1. The vertical magnetic field coils 32A and 32B are formed inside the helical coils 30. The vertical magnetic field coils 33A and 33B are formed outside the helical coils 30. Each of the vertical magnetic field coils 32A, 32B, 33A, and 33B includes the coil housings. The superconducting wire (not shown) and the cooling pipe (not shown) for cooling the superconducting wire are housed in the hollow pipes formed inside the coil housing.

### Cryostat

As shown in FIG. 7A, the cryostat 40 has an upper wall 41 covering the upper side of the helical coils 30. The cryostat 40 has an inner wall 42 disposed inside the helical coils 30 (on the vertical center line C1 side) and an outer wall 43 disposed outside the helical coils 30 (on the opposite side of the inner wall 42 across the helical coils 30). The cryostat 40 also has a bottom wall 44 disposed below the helical coils 30.

The reactor main body M may have n modules. Each module constitutes a portion corresponding to 360/n degrees of the entire reactor main body M. FIG. 7A only shows one module. In the reactor main body M, the plurality of the parts shown in FIG. 7A are arranged in the circumferential direction Dr of the reactor main body M so as to constitute the annular reactor main body M (see FIG. 5). As such, in a plan view of the reactor main body M, the upper wall 41 and the bottom wall 44 have an annular shape around the vertical center line C1, and the inner wall 42 and the outer wall 43 have a cylindrical shape surrounding the vertical center line C1.

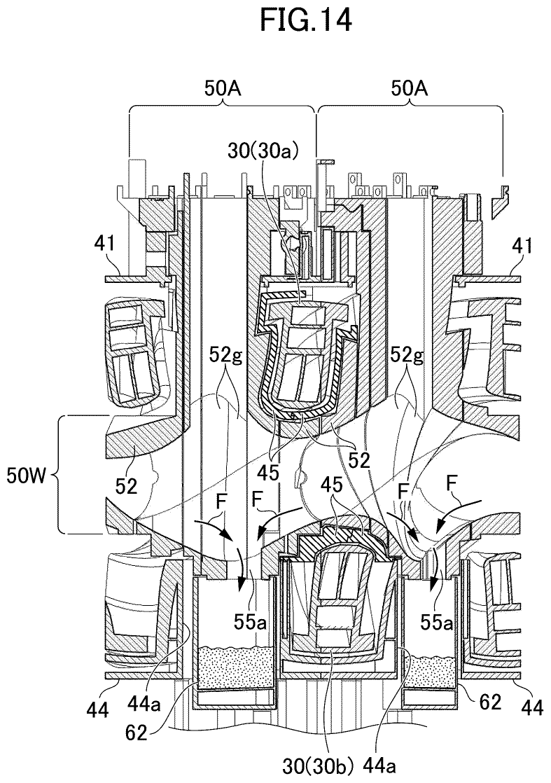

As will be described later, the blanket 50 includes a plasma-facing wall 50W (see FIG. 11) at the lower portion thereof. The plasma-facing wall 50W is disposed inside the helical coils 30 and has a cylindrical shape extending along the circumferential direction Dr of the reactor main body M. As shown in FIG. 14, the cryostat 40 has an inner shielding wall 45. The inner shielding wall 45 is located between the plasma-facing wall 50W and the helical coils 30. The inner shielding wall 45 protects the helical coils 30 from radiation and particles generated from the plasma.

The inner shielding wall 45 forms a sealed space between the other walls of the cryostat 40 (i.e., the upper wall 41, the inner wall 42, the outer wall 43, the bottom wall 44) and the inner shielding wall 45. The helical coils 30 is located in the sealed space. The sealed space is isolated from the other space within the vacuum vessel 20. This structure secures a higher degree of vacuum in the other space within the vacuum vessel 20.

That is, this structure secures a higher degree of vacuum in the space in which the plasma is generated inside the plasma-facing wall 50W. Further, this structure thermally insulates the helical coils 30 from the other space of the vacuum vessel 20.

### Blanket

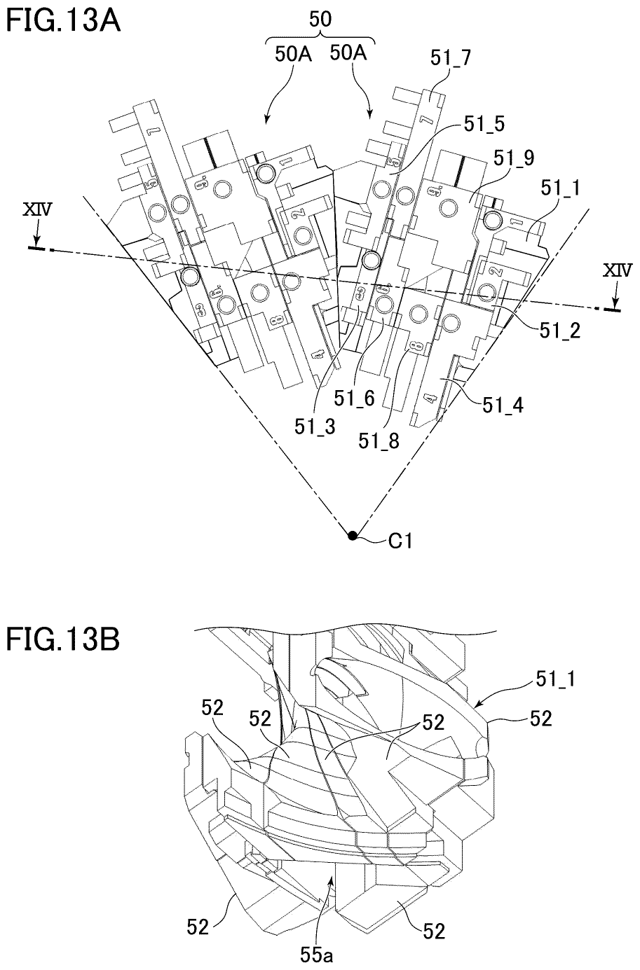

The blanket 50 includes a module assembly 50A (see FIG. 11). The n module assemblies 50A are arranged in the circumferential direction Dr of the reactor main body M so as to form the annular blanket 50 centered on the vertical center line C1 (in FIG. 13A, two module assemblies 50A are shown). In the example of the present specification, the blanket 50 has ten module assemblies 50A. The ten module assemblies 50A may have the same structure.

The number of module assemblies 50A may be less than ten or more than ten. The number of module assemblies 50A may be changed in accordance with the size of the reactor main body M and the pitch of the helical coils 30 (the distance between coil upper-halves 30a described later).

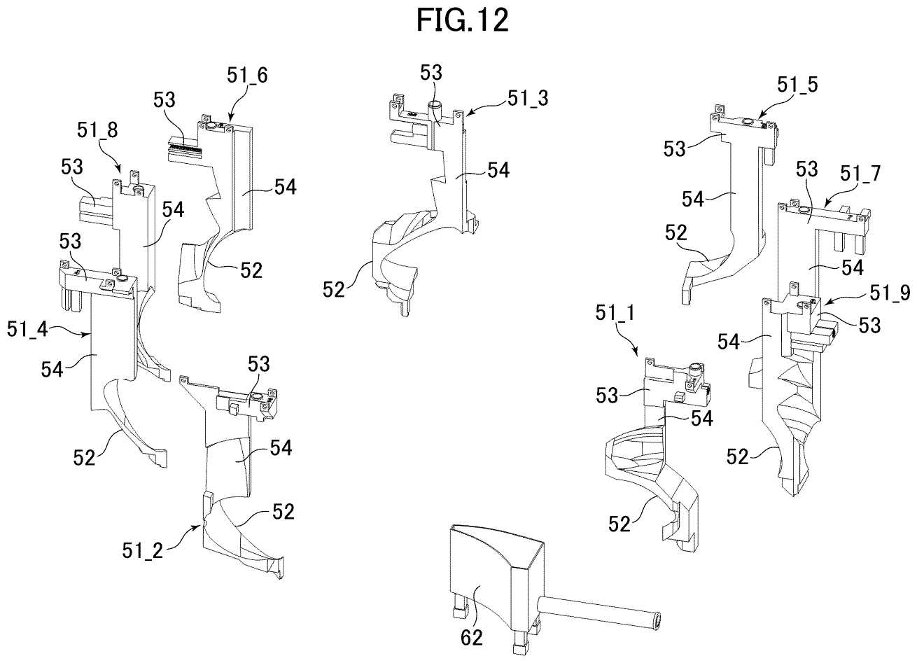

Each module assembly 50A has m blanket modules 51_1 to 51_9 (see FIG. 12). The m blanket modules 51_1 to 51_9 may have different shapes from each other. In the example of the present specification, each module assembly 50A has nine blanket modules 51. The shapes of the first to ninth blanket modules 51_1 to 51_9 are designed to be able to pass between two adjacent coil upper-halves 30a.

In the following, a numerical reference “51” is used for the blanket modules in a description where the nine blanket modules 51_1 to 51_9 are not identified.

As shown in FIG. 12, each blanket module 51 has a module lower portion 52 at a lower portion thereof. The module lower portion 52 functions as a part of the annular plasma-facing wall 50W centered on the vertical center line C1. Each blanket module 51 has, on its top, a module upper portion 53 supported by the upper wall 41 of the cryostat 40. Each blanket module 51 has a flow path portion 54 extending from the module upper portion 53 to the module lower portion 52.

The plasma-facing wall 50W is annular about the vertical center line C1 of the reactor main body M. The module lower portions 52 of m blanket modules 51 constituting one module assembly 50A are combined with each other to form a part of the annular plasma-facing wall 50W (plasma-facing wall having a width corresponding to 360/n degrees). As described above, in the example of the present specification, the blanket 50 has ten module assemblies 50A. As such, the module lower portions 52 of each blanket module 51 are combined with each other to form a width corresponding to 36 degrees of the entire plasma-facing wall 50W.

The number of blanket modules 51 may be less than nine or more than nine. The number of blanket modules 51 may be changed according to the size and shape of the module assembly 50A.

### Structure Relating to Flow of Liquid Breeding Material

The inside of each blanket module 51 is configured to allow liquid breeding material to flow from the module upper portion 53 to the module lower portion 52. As shown in FIG. 11, a feed port 53a of the liquid breeding material is formed in the module upper portion 53. The feed port 53a is formed on the upper surface of the module upper portion 53. The reactor main body M has a plurality of upper pools 61. The positions of the upper pools 61 respectively correspond to the positions of the module assemblies 50A. The liquid breeding material is supplied from the outside of the vacuum vessel 20 to the upper pool 61 through a feed pipe 4c (see FIG. 6B). The upper pool 61 is connected to the feed port 53a of the blanket module 51, and supplies the liquid breeding material to the respective blanket modules 51. A plurality of connecting pipes 61a (see FIG. 11) connected to the feed port 53a of the blanket module 51 may be formed at the bottom of the upper pool 61.

The flow path portion 54 (see FIG. 12) between the module upper portion 53 and the module lower portion 52 is tubular, and the liquid breeding material flows through the inside thereof. The module lower portion 52 is configured such that the liquid breeding material passes through the inside thereof and is exposed from a surface 52g of the module lower portion 52 (see FIG. 14, surface facing the plasma). (In FIG. 14, the flow of leaked liquid breeding material is partially indicated by arrows F.)

The module lower portion 52 may be formed of a porous material, for example. The liquid breeding material having passed through the flow path portion 54 passes through the porous module lower portion 52, and is exposed from the surface 52g of the module lower portion 52 to form a free surface. As such, the liquid breeding material can function as a first wall. Such porous materials of the module lower portion 52 may be titanium, a titanium alloy, and high manganese steel.

As shown in FIG. 14, a lower pool 62 opened upward is disposed at the lower part of the module assembly 50A. The opening of the lower pool 62 may fit into the lower end of the module assembly 50A. An opening 44a (see FIG. 14) may be formed in the bottom wall 44 of the cryostat 40, and the lower pool 62 may be fitted into the opening 44a from below.

As shown in FIG. 14, the liquid breeding material leaked from the surface 52g of the module lower portion 52 flows into the lower pool 62. A discharge pipe 62a (see FIG. 11) is connected to the lower pool 62. As shown in FIG. 3, the discharge pipe 62a may extend from an opening formed in the outer peripheral wall 22 of the vacuum vessel 20 to the outside of the vacuum vessel 20. The liquid breeding material discharged from the lower pool 62 is sent to the heat exchanger 4a and the tritium recovery device 4b (see FIG. 2) installed on the outside of the vacuum vessel 20.

As shown in FIG. 13B, the blanket modules 51 are combined with each other to form an opening 55a at the lower end thereof (hereinafter, such an opening is referred to as a “discharge opening”). The discharge opening 55a facilitates flow of the liquid breeding material from the surface 52g of the module lower portion 52 to the lower pool 62. Further, for example, helium ash from the divertor plasma formed in the vicinity of the discharge opening 55a of the module lower portion 52 can be efficiently discharged to the lower pool 62 together with the liquid breeding material.

The discharge opening 55a is formed between two adjacent coil lower-halves 30b of the helical coils 30. The coil lower-half 30b is a portion of the helical coil 30 located below the horizontal plane P1 (see FIG. 10C) which passes through the center of the helical coil 30 in the vertical direction. A gap is formed between two adjacent coil lower-halves 30b. The gap formed between the two adjacent coil lower-halves 30b gradually increases toward the outer side in the radial direction of the reactor main body M. The discharge opening 55a may be wider toward the outer side of the radial direction of the reactor main body M in accordance with the gap formed between the two coil lower-halves 30b. This facilitates the flow of the liquid breeding material.

### Removal of Blanket Module

The radiation and particles from the plasma are incident on the module lower portion 52 of the blanket module 51 and degrade the material of the module lower portion 52. As such, the blanket module 51 needs to be periodically replaced and maintained. In order to improve the efficiency of such an operation, each blanket module 51 can be moved upward through a gap A (see FIG. 10B) formed in the helical coil 30.

Specifically, as shown in FIGS. 10B and 10C, the helical coils 30 have a plurality of coil upper-halves 30a arranged in the circumferential direction Dr of the reactor main body M. The coil upper-half 30a is a portion of the helical coil 30 located above the horizontal plane P1 (see FIG. 10C) which passes through the center of the helical coil 30 in the vertical direction. A gap A (see 10B) is formed between two adjacent coil upper-halves 30a. In a plan view of the helical coils 30, the module assemblies 50A are respectively disposed in the gaps A. Each blanket module 51 can be moved upwards through the gap A. Further, the blanket module 51 after maintenance or a new blanket module 51 can be moved downward through the gap A.

As described above, the upper wall 41 of the cryostat 40 covers the upper side of the helical coils 30. As shown in FIG. 8, an opening 41a corresponding to the gap A is formed in the upper wall 41. The blanket module 51 can be moved up and down through the opening 41a.

### Module Lower Portion of First and Second Blanket Modules

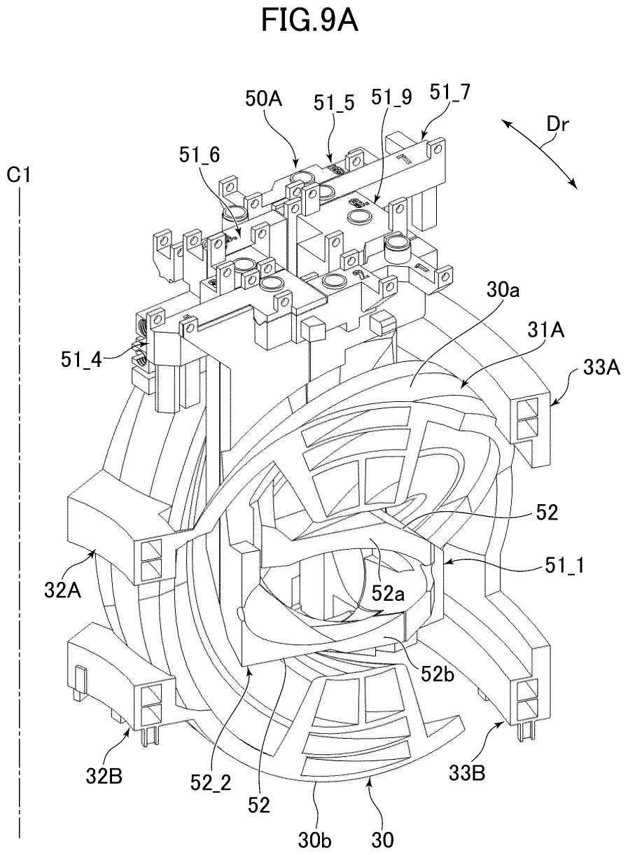

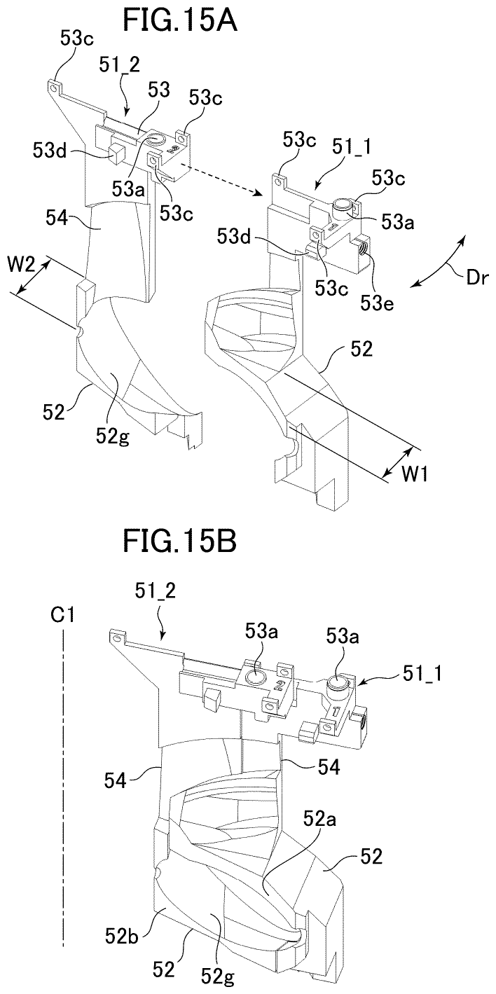

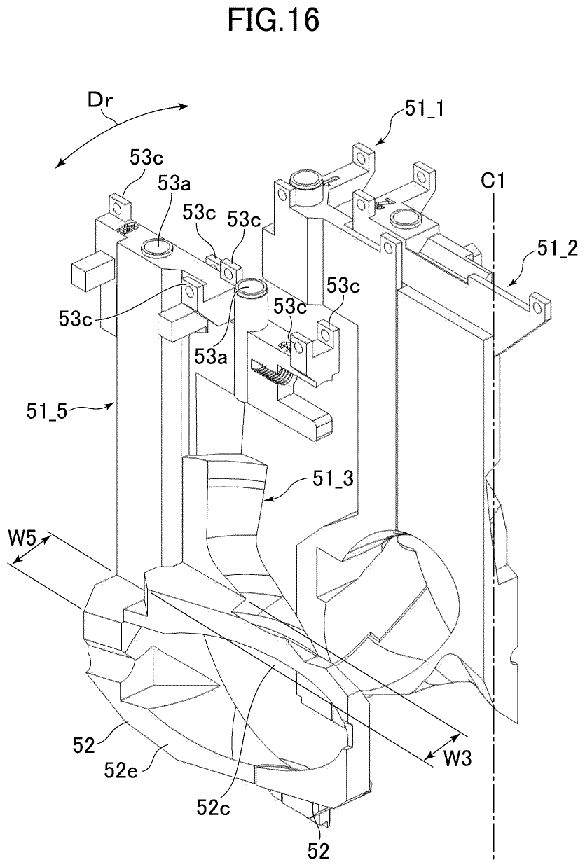

The blanket modules 51_1 and 51_2 shown in FIG. 15A are disposed closer to one of the two adjacent coil upper-halves 30a. The module lower portion 52 of the first blanket module 51_1 protrudes by a width W1 more than the flow path portion 54 in the circumferential direction Dr of the reactor main body M. As shown in FIG. 9A, the module lower portion 52 of the of the first blanket module 51_1 is located under the coil upper-half 30a and overlaps the coil upper-half 30a in a plan view of the helical coil 30.

As shown in FIG. 15B, the second blanket module 51_2 is combined with the first blanket module 51_1 in the radial direction of the reactor main body M. The module lower portion 52 of the first blanket module 51_1 is substantially U-shaped opening toward the vertical center line C1. On the other hand, the module lower portion 52 of the second blanket module 51_2 is substantially U-shaped opening toward the opposite side (outward) of the vertical center line C1. The two module lower portions 52 are combined with each other to form an annular shape in a cross-sectional view along the vertical center line C1.

As shown in FIG. 15B, the module lower portion 52 of the second blanket module 51_2 protrudes by a width W2 more than the flow path portion 54 in the circumferential direction Dr of the reactor main body M. The module lower portion 52 is located under the coil upper-half 30a and overlaps the coil upper-half 30a in a plan view of the helical coil 30.

The widths W1 and W2 of the module lower portions 52 of the first and second blanket modules 51_1 and 51_2 can substantially eliminate the gap between the plasma-facing walls 50W formed by the two adjacent module assemblies 50A.

In order to move the first and second blanket modules 51_1 and 51_2 upward from the gap A (in other words, the opening 41a of the cryostat 40) of the helical coils 30, the blanket modules 51_1 and 51_2 need to move in the circumferential direction Dr of the furnace main body M. Such movement can be achieved by the first transport mechanism 71 (see FIG. 3) of the transport system 70 installed in the bioshield 5. [Module upper portion of first and second blanket modules] The module upper portion 53 of the first blanket module 51_1 (see FIG. 15A) is positioned above the coil upper-half 30a, and overlaps with the coil upper-half 30a when the helical coil 30 is viewed in a plan view. The flow path portion 54 of the first blanket module 51_1 is located along the side surface of the coil upper-half 30a.

The module upper portion 53 of each blanket module 51 is supported by the edge of the opening 41a (see FIG. 8) formed in the upper wall 41 of the cryostat 40. As shown in FIG. 17, the upper wall 41 may include a sliding mechanism for sliding the module upper portion 53 in the radial direction of the reactor main body M. The sliding mechanism may include a feed screw, for example. Specifically, a feed screw 49 may be installed on the upper wall 41, and a screw hole 53e may be formed on the module upper portion 53, for example. The sliding mechanism allows the first blanket module 51_1, for example, to move in the radial direction of the reactor main body M.

Each blanket module 51 can be moved up and down without interfering with the coil upper-half 30a by combining the movement of the blanket module 51 in the radial direction, the movement of the reactor main body M in the circumferential direction Dr, and the tilt of the blanket module 51 by a winding device to be described later.

As the first and second blanket modules 51_1 and 51_2 are combined, the module upper portion 53 of the second blanket module 51_2 is supported by the upper side of the module upper portion 53 of the first blanket module 51_1. The module upper portions 53 of the two blanket modules 51 overlap in this manner, and this allows multiple module upper portions 53 to be supported by the edge of the opening 41a of a limited size.

As shown in FIG. 15A, a plurality of guided portions 53d may be formed on the module upper portion 53. Each of the guided portions 53d may be a projection projecting downward from the module upper portion 53 or a projection projecting in the circumferential direction Dr of the reactor main body M from the module upper portion 53. The guided portion 53d is fitted into a guide portion (recessed portion) formed in the upper wall 41 of the cryostat 40, and fixes the position of the blanket module 51 at a predetermined appropriate position.

### Third and Fifth Blanket Modules

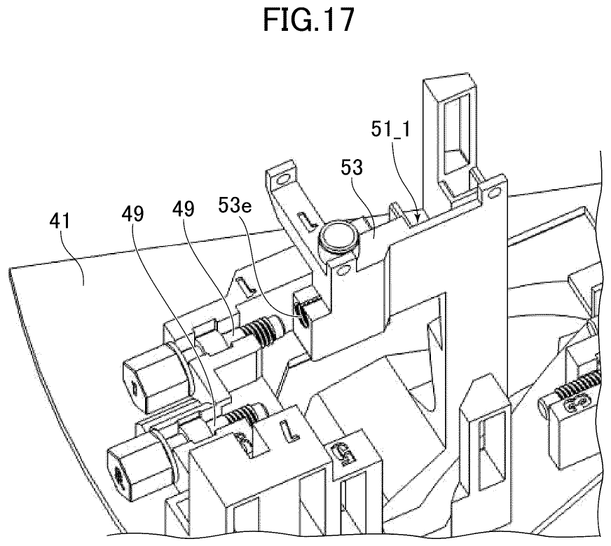

The third blanket module 51_3 and the fifth blanket module 51_5 shown in FIG. 16 are disposed on the opposite sides of the first and second blanket modules 51_1 and 51_2 in the circumferential direction Dr of the reactor main body M. That is, the blanket modules 51_3 and 51_5 are disposed closer to the other one of the two adjacent coil upper-halves 30a.

As shown in FIG. 16, the module lower portion 52 of the fifth blanket module 51_5 is substantially U-shaped opening toward the vertical center line C1. On the other hand, the module lower portion 52 of the third blanket module 51_3 is substantially U-shaped opening toward the opposite side (outward) of the vertical center line C1. The two module lower portions 52 are combined with each other to form an annular shape in a cross-sectional view along the vertical center line C1.

As shown in FIG. 16, the module lower portion 52 of the third blanket module 51_3 protrudes by a width W3 more than the flow path portion 54. Further, the module lower portion 52 of the fifth blanket module 51_5 protrudes by the widthwise W5. As shown in FIG. 9B, the two module lower portions 52 are located under the coil upper-half 30a and overlap the coil upper-half 30a in a plan view of the helical coil 30.

The widths W3 and W5 of the module lower portions 52 of the third and fifth blanket modules 51_3 and 51_5 can substantially eliminate the gap between the plasma-facing walls 50W of the two adjacent module assemblies 50A.

More specifically, the gap between the module lower portions 52 of the first and second blanket modules 51_1 and 51_2 of one of two adjacent module assemblies 50A and the module lower portions 52 of the third and fifth blanket modules 51_3 and 51_5 of the other one of the two adjacent module assemblies 50A may be substantially eliminated. This structure allows the annular plasma-facing wall 50W, centered on the vertical center line C1, to be formed using only the blanket module 51 that can be pulled upwardly.

In order to move the third and fifth blanket modules 51_3 and 51_5 upward from the helical coils 30, the blanket modules 51_3 and 51_5 need to move in the circumferential direction Dr of the reactor main body M. Such movement can also be achieved by the first transport mechanism 71 (see FIG. 3) of the transport system 70 installed in the bioshield 5.

### Upper Portion of Third Blanket Module

As shown in FIG. 9B, at least a part of the module upper portion 53 of the third blanket module 51_3 is positioned above the coil upper-half 30a and overlaps with the coil upper-half 30a. Similarly, a part of the module upper portion 53 of the fifth blanket module 51_5 is positioned above the coil upper-half 30a and overlaps with the coil upper-half 30a.

The module upper portion 53 of the third blanket module 51_3 is also supported by the edge of the opening 41a formed in the upper wall 41 of the cryostat 40. The upper wall 41 may include a sliding mechanism for sliding the module upper portion 53 of the third blanket module 51_3. The sliding mechanism may include a feed screw 49, for example. The feed screw 49 may be installed on the upper wall 41, and a screw hole 53e may be formed on the module upper portion 53, for example. Such a sliding mechanism allows the third blanket module 51_3 to move in the radial direction of the reactor main body M.

Similarly to the first and second blanket modules 51_1 and 51_2 described above, when the third and fifth blanket modules 51_3 and 51_5 are combined, the module upper portion 53 of the fifth blanket module 51_5 is supported by the upper side of the module upper portion 53 of the third blanket module 51_3 (see FIG. 16). One of the module upper portions 53 of the two blanket modules 51 overlap the other, and this allows multiple module upper portions 53 to be supported by the edge of the opening 41a of a limited size.

### Other Blanket Modules

As shown in FIG. 13A, other blanket modules 51 (i.e., fourth, sixth to ninth blanket modules 51) are disposed between the first and second blanket modules 51_1 and 51_2 disposed closer to one of the coil upper-halves 30a and the third and fifth blanket modules 51_3 and 51_5 disposed closer to the other one of the coil upper-halves 30a.

The fourth, sixth to ninth blanket modules 51 may not have the widths W1 to W3 and W5, unlike the blanket modules 51 disposed on both sides thereof (i.e., first to third and fifth blanket modules 51). Accordingly, the fourth, sixth to ninth blanket modules 51 may be vertically movable straight up and down.

### Distance Between Two Adjacent Module Assemblies

The blanket 50 has n module assemblies 50A (ten in the example described in this specification) that arranged over the entire circumference in the circumferential direction Dr of the reactor body M about the vertical center line C1. Each module assembly 50A includes m blanket modules 51 (nine in the example described herein). The module lower portions 52 of the m blanket modules 51 are combined with each other to form a plasma-facing wall 50W having a width corresponding to 360/n degrees (36 degrees in the example described herein) about the vertical center line C1.

As such, as shown in FIG. 14, when viewing a cross section of two adjacent module assemblies 50A, side surfaces 52a and 52b (see FIG. 9A) of the module lower portion 52 of one of the module assemblies 50A and side surfaces 52c and 52e (see FIG. 9B) of the module lower portion 52 of the other one of the module assemblies 50A are close to each other. In this regard, “side surfaces are close to each other” means that there is no gap exceeding the clearance required for manufacturing. There need not be a blanket that is not allowed to move upwards between the side surfaces 52a and 52b and the side surfaces 52c and 52e.

The surface 52g (plasma-facing surface, see FIG. 14) of the module lower portion 52 of one of the module assemblies 50A and the surface 52g of the module lower portion 52 of the other one of the module assemblies 50A form a curved surface that is contiguous in the circumferential direction Dr of the reactor main body M. This allows the liquid breeding material leaking from the surface 52g to smoothly flow to the discharge opening 55a formed at the lower end of the module assembly 50A.

As shown in FIG. 7B, the blanket 50 may include a test module 59. Unlike the blanket module 51 described above, the test module 59 may be slidable in the radial direction of the reactor main body M. The end 59a (end closer to the plasma) of the test module 59 does not protrude inward of the helical coils 30 beyond the position of the surface 52g of the module lower portion 52.

The structure of the blanket 50 is not limited to the example described here. For example, each module assembly 50A may include a blanket module that forms a part of the plasma-facing wall 50W and is slidable in the radial direction of the reactor main body M. That is, the module assembly 50A may include a blanket module 51 that can be pulled upward through the gap A of the helical coils 30 and a blanket module that can be slid in the radial direction of the reactor main body M. In this case, an opening for removing the blanket module from the vacuum vessel 20 may be formed in the outer peripheral wall 22 of the vacuum vessel 20.

### Movable Cover of Vacuum Vessel

As shown in FIG. 4, the vacuum vessel 20 includes a movable cover 21 that is openable and closable and covers the upper sides of the helical coils 30, the cryostat 40, and the blanket 50, for example. The movable cover 21 covers all of the n module assemblies 50A disposed in the circumferential direction Dr of the reactor main body M. That is, the movable cover 21 covers the reactor main body M over an angular range of 360 degrees centered on the vertical center line C1.

As shown in FIG. 4, the movable cover 21 may be supported via a hinge 29a disposed on the outside of an outer peripheral edge 21a of the movable cover 21. The movable cover 21 is opened and closed around the hinge 29a.

As shown in FIG. 4, a support structure 29 for supporting the movable cover 21 is installed in the bioshield 5. The support structure 29 supports the movable cover 21 via the hinge 29a. An example of the support structure 29 includes columnars that stands along the outside of the outer peripheral wall 22 of the vacuum vessel 20, although the support structure 29 is not limited to the example shown in FIG. 4.

When the movable cover 21 is opened and closed, the whole movable cover moves integrally around the hinge 29a. Such a structure serves to efficiently open and close the movable cover compared to the case where a plurality of movable covers are respectively disposed on the upper sides of n module assemblies 50A, for example.

As shown in FIG. 3, the transport system 70 is provided above the vacuum vessel 20. The movable cover 21 may be opened and closed by the transport system 70. For example, one or more engaged portions 21d (see FIG. 6B) may be provided on the upper surface of the movable cover 21. The transport system 70 may include a hook (engaging portion) provided at a distal end of a wire 73a. The transport system 70 may hook the hook onto the engaged portion 21d to pull up a portion of the movable cover 21 away from the structure 29.

The support structure and the opening and closing method of the movable cover 21 are not limited to the examples described here. For example, the movable cover 21 may be supported without the hinge 29a. In this case, the whole movable cover 21 may be movable up and down by the transport system 70, for example, while maintaining the horizontal posture of the movable cover 21.

### Joining and Releasing Movable Cover and Outer Peripheral Wall

As shown in FIG. 6B, the outer peripheral edge 21a of the movable cover 21 may be airtightly joined to the upper edge 22a of the outer peripheral wall 22 of the vacuum vessel 20, for example. The outer peripheral edge 21a of the movable cover 21 may spread outwardly in the radial direction to form a ring portion (flange) surrounding the vertical center line C1. The upper edge 22a of the outer peripheral wall 22 may also spread outwardly in the radial direction to form a ring portion (flange) surrounding the vertical center line C1. These two ring portions (21a and 22a) may be welded. This can ensure the airtightness of the vacuum vessel 20.

As shown in FIG. 6B, the vacuum vessel 20 may have a release device 27 for releasing the joint between the movable cover 21 and the outer peripheral wall 22. When the movable cover 21 and the outer peripheral wall 22 are welded together, the release device 27 may include a cutting machine for cutting off the welded portion thereof, for example.

The release device 27 may be movable along the outer peripheral edge 21a of the movable cover 21. As shown in FIG. 6B, the vacuum vessel 20 may have a guide 22b extending along the outer peripheral edge 21a of the movable cover 21, for example. The guide 22b may be fixed to the uppermost portion of the outer peripheral wall 22. The guide 22b may be formed over the entire circumference of the vacuum vessel 20. The release device 27 may be movable along the guide 22b over 360 degrees in the circumferential direction Dr of the reactor main body M. The release device 27 may move along the guide 22b while releasing the joint between the movable cover 21 and the outer peripheral wall 22, that is, while cutting the welded part. Such a release device 27 can efficiently open the movable cover 21.

In a structure where the end of the ring portion in the radial direction, which is the outer peripheral edge 21a of the movable cover 21 (the outermost portion of the movable cover in the radial direction) and the end of the ring portion in the radial direction, which is the upper edge 22a of the outer peripheral wall 22, are welded together, the release device 27 (cutting machine) cuts out only the end portions of the ring portions. That is, the ends of the ring portions that were welded may be removed from the rest of the ring portions. This allows the movable cover 21 and the outer peripheral wall 22 to be separated from each other. In order to fix the movable cover 21 to the outer peripheral wall 22 again, the rest of the ring portion, which is the outer peripheral edge 21a of the movable cover 21, and the rest of the ring portion, which is the upper edge 22a of the outer peripheral wall 22, may be welded. This enables the movable cover 21 to be repeatedly used.

The release device 27 may be configured such that the position of the release device 27 is adjustable in the radial direction of the reactor main body M. According to this mechanism, the position of the release device 27 can be brought close to the outer peripheral edge 21a of the movable cover 21 in a case where, for example, the opening and closing operation of the movable cover 21 is repeated and the distance between the guide 22b and the outer peripheral edge 21a is thereby increased.

As shown in FIG. 6A, the vacuum vessel 20 may include a joining device 28 for joining the movable cover 21 and the outer peripheral wall 22. The joining device 28 may include a welder that welds the outer peripheral edge 21a (ring portion) of the movable cover 21 and the upper edge 22a (ring portion) of the outer peripheral wall 22, for example.

Similarly to the release device 27, the joining device 28 may also be movable along the outer peripheral edge 21a of the movable cover 21. For example, the joining device 28 may also be movable over 360 degrees in the circumferential direction Dr of the reactor main body M along the guide 22b extending along the outer peripheral edge 21a of the movable cover 21. The joining device 28 may move along the guide 22b while joining the movable cover 21 and the outer peripheral wall 22, i.e., welding them together. Such a joining device 28 serves to efficiently close the movable cover 21.

The joining device 28 may be configured such that the position of the joining device is adjustable in the radial direction of the reactor main body M. According to this mechanism, the position of the joining device 28 can be brought close to the outer peripheral edge 21a of the movable cover 21 in a case where, for example, the opening and closing operation of the movable cover 21 is repeated and the distance between the guide 22b and the outer peripheral edge 21a is thereby increased.

### Other Structures of Vacuum Vessel

The structure of the vacuum vessel 20 is not limited to the examples described above. For example, although FIG. 6A shows only one joining device 28, a plurality of joining devices 28 may be movable along the guide 22b. Similarly, in FIG. 6A, for example, a plurality of release devices 27 may be movable along the guide 22b. Such a structure serves to more efficiently open and close the movable cover 21.

In still another example, the ring portion of the outer peripheral edge 21a of the movable cover 21 and the ring portion of the upper edge 22a of the outer peripheral wall 22 may be bolted together. In this case, a device (robot) for fastening and releasing the bolts may be used as the release device 27 and the joining device 28. In this case as well, such a device may be movable along the guide 22b.

In the example shown in FIG. 5, one movable cover 21 covers the entire circumference of the reactor main body M in the circumferential direction Dr of the reactor main body M. Alternatively, the vacuum vessel 20 may have a plurality of movable covers connected to each other and arranged in the circumferential direction Dr of the reactor main body M. Each movable cover may cover the upper sides of the two adjacent module assemblies 50A.

In other words, the first movable cover may cover the upper sides of two adjacent module assemblies 50A (first and second module assemblies 50A). The entire first movable cover may move in the opening/closing operation. The second movable cover disposed next to the first movable cover may also cover the upper sides of the two adjacent module assemblies 50A (third and fourth module assemblies 50A). The whole second movable cover may move in the opening/closing operation. For example, the vacuum vessel 20 may have two movable covers. In this case, one of the movable covers may cover half of the n module assemblies 50A and the other one of the movable covers may cover the other half. Such a structure also serves to improve the opening and closing operations of the movable cover compared to, for example, a structure where one movable cover covers only one module assembly 50A.

When the joint between the outer peripheral edge 21a of the movable cover 21 and the upper edge 22a of the outer peripheral wall 22 is released, for example, when the welded part is cut, dust and offcuts are generated. The vacuum vessel 20 may have a device that absorbs such dust and offcuts. For example, such an absorber may also be movable along the guide Alternatively, the absorber may be suspended by the 22b. transport system 70, and moved along the outer peripheral edge 21a of the movable cover 21.

### Relationship Between Piping for Supplying Liquid Breeding Material and Movable Cover

As shown in FIG. 6B, a plurality of joint pipes 21c are fixed to the movable cover 21. The joint pipes 21c move integrally with the movable cover 21 in the opening and closing operation of the movable cover 21. The joint pipes 21c are positioned on the upper side of the n module assemblies 50A (more specifically, on the upper side of the upper pools 61). The liquid breeding material is supplied to each of the module assemblies 50A through the joint pipes 21c.

As described above, the liquid breeding material circulation system 4 has a plurality of feed pipes 4c (see FIG. 6B). The feed pipe 4c extends from the outside to the inside of the bioshield 5 in the radial direction of the reactor main body M. The ends of the feed pipes 4c are respectively connected to the joint pipes 21c.

The end of the feed pipe 4c may be separable from the joint pipe 21c. For example, flanges may be formed at the end of the feed pipe 4c and the end of the joint pipe 21c, and these two flanges may be fastened by bolts. In this case, the helical fusion reactor 10 may include a remote-controlled robot (not shown) for fastening and unfastening the bolts. The remote-controlled robot may be controllable from the outside of the bioshield 5. The remote-controlled robot may also be movable along the guide 22b formed along the outer peripheral wall 22 of the vacuum vessel 20 in the circumferential direction Dr of the reactor main body M, for example.

As shown in FIG. 6A, all of the joint pipes 21c are positioned inside the outer peripheral edge 21a of the movable cover 21 in a plan view of the vacuum vessel 20. The feed pipe 4c is movable in the radial direction of the reactor main body M. More specifically, the end of the feed pipe 4c (the connecting portion with the joint pipe 21c) is movable to the outside of the outer peripheral edge 21a of the movable cover 21. The feed pipe 4c may be moved in this manner by, for example, the transport system 70 described later.

### Transport System

As shown in FIG. 3, the transport system 70 may include a crane, for example. The transport system 70 includes a moving device 73 on which winding mechanism of wires 73a are mounted. The blanket modules 51 are respectively hooked to the engaging portions (hooks) provided at the ends of the wires 73a. As shown in FIG. 2, the transport system 70 includes a first transport mechanism 71 and a second transport mechanism 72. The first transport mechanism 71 moves the blanket module 51 upwardly from the reactor main body M. The second transport mechanism 72 moves the blanket module 51 from a position above the reactor main body M to a storage chamber 5a of the blanket module 51 in the bioshield 5.

As shown in FIG. 3, the first transport mechanism 71 includes a rotation support rail 71a and a traveling rail 71b. For example, the rotation support rail 71a may have an annular shape about the vertical center line C1. The both ends of the traveling rail 71b may be supported by the rotation support rail 71a, and the traveling rail 71b may be rotatable in the circumferential direction Dr of the reactor main body M. The moving device 73 is supported by the traveling rail 71b and is movable in the radial direction of the reactor main body M.

The first transport mechanism 71 described above enables the blanket module 51 to move not only in the up-down direction but also in the circumferential direction Dr of the reactor main body M. As such, the blanket module 51 is allowed to easily move to an appropriate position between two adjacent coil upper-halves 30a (FIG. 10B). For example, the first to third, and fifth blanket modules 51_1, 51_2, 51_3, and 51_5 described above are allowed to move in the circumferential direction Dr of the reactor main body M.

As shown in FIGS. 15A and 16, a plurality of engaged portions 53c are preferably formed on the module upper portions 53 of the respective blanket modules 51. A plurality of winding devices are preferably mounted on the moving device 73. The plurality of engaging portions (hooks) provided at the ends of the wires 73a extending from the winding device may be respectively coupled to the engaged portions 53c.

The number of the engaged portions 53c of the module upper portion 53 may be three, for example. The three engaged portions 53c are preferably spaced apart from each other in the circumferential direction Dr and in the radial direction of the reactor main body M. This structure serves to control the posture of the blanket module 51 when the blanket modules 51 are moved. The number of the engaged portions 53c is not limited to three.

For example, the blanket module 51 can be tilted with respect to the vertical center line C1. More specifically, the blanket module 51 can be tilted toward one side in the radial direction of the reactor main body M, or toward one side in the circumferential direction Dr of the reactor main body M. This mechanism serves to avoid interference between the blanket module 51 and other components.

The feed pipe 4c of the liquid breeding material circulation system 4 may also be movable by the first transport mechanism 71. For example, an engaged portion may be provided in the feed pipe 4c. The first transport mechanism 71 may move the position of the feed pipe 4c such that the end portion of the feed pipe 4c (the connecting portion with the joint pipe 21c) moves to the outside of the outer peripheral edge 21a of the movable cover 21. In this case, the feed pipe 4c may include an expansion joint adjustable in the length.

As shown in FIG. 2, the second transport mechanism 72 may have a traveling rail 72a. The traveling rail 72a extends from a position above the vacuum vessel 20 to the storage chamber 5a. The traveling rail 71b (see FIG. 3) that is rotatable along the rotation support rail 71a can be aligned with the traveling rail 72a. In such a condition, the moving device 73 can move between the traveling rail 71b and the traveling rail 72a.

In this mechanism, the blanket module 51 pulled up from the reactor main body M by the first transport mechanism 71 can be transported to the storage chamber 5a. On the other hand, the blanket module 51 stored in the storage chamber 5a can be moved from the storage chamber 5a to the reactor main body M.

### Maintenance Operation

In the following, the maintenance work of the blanket module 51 will be described.

First, a remote-controlled robot is used to release the joint between the feed pipes 4c and the joint pipes 21c of the movable cover 21 (S101). The first transport mechanism 71 is then used to move the feed pipes 4c in the radial direction of the reactor main body M, and the end portions thereof are moved to the outside of the outer peripheral edge 21a of the movable cover 21 (S102).

Subsequently, the release device 27 is operated to cut the weld between the movable cover 21 and the outer peripheral wall 22 (S103). At this time, the release device 27 is controlled to circle the outer peripheral edge 21a of the movable cover 21. If the vacuum vessel 20 has a plurality of release devices 27, they may be operated simultaneously. The movable cover 21 is then opened (S104). The movable cover 21 may be opened by the first transport mechanism 71 of the transport system 70, for example.

Subsequently, the first transport mechanism 71 is used to separate the upper pool 61, which was attached to the module assembly 50A, from the module assembly 50A (S105). The upper pool 61 may be moved to the storage chamber 5a using, for example, the first transport mechanism 71 and the second transport mechanism 72.

Subsequently, nine blanket modules 51 constituting the module assembly 50A to be maintained are sequentially separated from the reactor main body M (S106). The separated blanket modules 51 are moved to the storage chamber 5a by using the first transport mechanism 71 and the second transport mechanism 72 (S107).

As shown in FIG. 13A, the blanket modules 51 may be numbered from 1 to 9. The numbers assigned to the blanket modules 51 correspond to the subscripts of their numerical references. In S106, the nine blanket modules 51 are sequentially separated in the order from the blanket module 51 disposed closer to the center in the circumferential direction

Dr of the reactor main body M. For example, the nine blanket modules 51 may be separated from the reactor main body M in the order of the ninth blanket module 51_9, the eighth blanket module 51_8, the seventh blanket module 51_7, and so on.

After the blanket modules 51 closer to the center are separated, the blanket modules 51 disposed on the outer side in the circumferential direction Dr of the reactor main body M may be separated. For example, the fifth blanket module 51_5, the fourth blanket module 51_4, the third blanket module 51_3, the second blanket module 51_2, and the first blanket module 51_1 having the module lower portions 52 positioned below the coil upper-halves 30a are separated in this order.

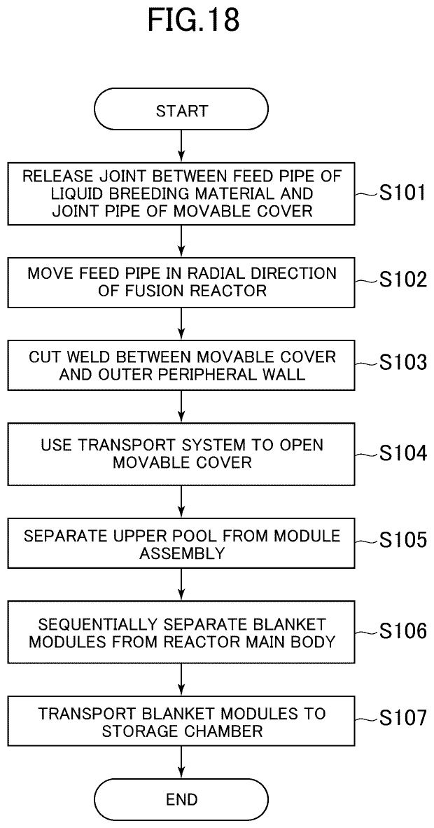

The blanket module 51 may be inserted into the reactor main body M in a reverse procedure to that shown in FIG. 18. That is, the blanket modules 51 are sequentially inserted between two adjacent coil upper-halves 30a in the order from the blanket modules 51 disposed closer to the outer side in the circumferential direction Dr of the reactor main body M. That is, the first blanket module 51_1, the second blanket module 51_2, the third blanket module 51_3, the fourth blanket module 51_4, and the fifth blanket module 51_5 having the module lower portions 52 positioned below the coil upper-halves 30a are inserted in this order.

The blanket modules 51 closer to the center are then inserted between the coil upper-halves 30a. That is, the sixth blanket module 51_6, the seventh blanket module 51_7, the eighth blanket module 51_8, and the ninth blanket module 51_9 are inserted between the coil upper-halves 30a in this order.

The inner shielding wall 45 of the cryostat 40 may have a guide surface for guiding the module lower portion 52 of the blanket module 51. The guide surface may be a slope that is tilted so that the module lower portion 52 of the blanket module 51 moves in the appropriate direction.

### Summary 1

As described above, the blanket 50 includes the plurality of module assemblies 50A disposed in the circumferential direction Dr around the vertical center line C1 of the helical coils 30, and each of the module assemblies 50A includes the plurality of blanket modules 51. Each of the blanket modules 51 is movable upward through the gap A formed in the helical coils 30. The vacuum vessel 20 includes the movable cover 21 that is openable and closable and covers the upper side of the helical coils 30 and the module assemblies 50A. The movable cover 21 is configured such that the whole movable cover 21 moves integrally when the movable cover 21 is opened and closed. Such a structure serves to efficiently open and close the movable cover 21. As such, the maintenance and replacement of the blanket can be more efficiently performed compared to the case where one movable cover is provided for each module assembly.

As described above, the helical coils 30 include the first coil upper-half 30a, the second coil upper-half 30a, and the third coil upper-half 30a, which are arranged in the circumferential direction Dr around the vertical center line C1 of the helical coils 30 and are positioned above the horizontal plane P1 passing through the center of the helical coils 30. The plurality of module assemblies 50A include the first module assembly 50A positioned between the first coil upper-half 30a and the second coil upper-half 30a and the second module assembly 50A positioned between the second coil upper-half 30A and the third coil upper-half in a plan view of the helical coils 30. The vacuum vessel 20 includes the movable cover 21 that is openable and closable and covers the upper side of the first module assembly 50A and the second module assembly 50A. Such a structure also serves to efficiently open and close the movable cover 21 compared to a structure where one movable cover is provided for each module assembly. In this structure, the vacuum vessel 20 may include a plurality of movable covers 21, which may be combined to cover the whole reactor main body M. In this case, two adjacent movable covers may be independently openable and closable.

The maintenance method described above includes a step of moving the release device 27 along the outer peripheral edge 21a of the movable cover 21 so as to release the joint between the outer peripheral edge 21a of the movable cover 21 and the other part of the vacuum vessel 20 (outer peripheral wall 22), a step of opening the movable cover 21, and a step of pulling up the blanket module 51 constituting the blanket 50 from the gap formed in the helical coil 30 by using the transport system 70. This method uses the release device 27 movable along the outer peripheral edge 21a of the movable cover 21. This serves to efficiently open the movable cover 21, whereby the blanket can be efficiently maintained and replaced.

### Summary 2

As described above, the blanket 50 has n module assemblies 50A that arranged over the entire circumference in the circumferential direction Dr of the reactor body M about the vertical center line C1. Each of the n module assemblies 50A has m blanket modules 51. The module lower portions 52 of the m blanket modules 51 of the respective module assemblies 50A are combined with each other to form the plasma-facing wall 50W having a length corresponding to 360/n degrees about the center line C1. All of m blanket modules 51 included in respective module assemblies 50A are movable upward from the gap (gap A between adjacent coil upper-halves 30a) formed in the helical coils 30. With this structure, the annular plasma-facing wall 50W centered on the vertical center line C1 can be formed only by the upwardly movable blanket modules 51.

The helical coils 30 include the first coil upper-half 30a and the second coil upper-half 30a that are adjacent in the circumferential direction Dr around the center line C1 along the vertical direction of the helical coils 30 and are positioned above the horizontal plane P1 passing through the center of the helical coils 30. The blanket 50 includes a plurality of module assemblies 50A arranged in the circumferential direction Dr of the reactor main body M, and each of the module assemblies 50A includes a plurality of blanket modules 51. The first module assembly 50A is disposed between the first coil upper-half 30a and the second coil upper-half 30a in a plan view of the helical coils 30, and is movable upward passing therebetween. The plurality of blanket modules 51 constituting the first module assembly 50A include the first and second blanket modules 51_1 and 51_2 at one of the end portions in the circumferential direction Dr of the reactor main body M, and constitute a part of the plasma-facing wall 50W. The module lower portions 52 of the first and second blanket modules 51_1 and 51_2 are positioned under the first coil upper-half 30a. The blanket modules 51 include the third and fifth blanket modules 51_3 and 51_5 at the other one of the end portions, and constitute another part of the plasma-facing wall 50W. The module lower portions 52 of the blanket modules 51_3 and 51_5 are positioned under the second coil upper-half 30a.

This structure serves to reduce or eliminate the number of blanket modules required to be slid in the radial direction of the reactor main body M in the maintenance and replacement operation of the blanket module 51.

In this structure, the module lower portions 52 of the first and second blanket modules 51_1 and 51_2 protrude more than the flow path portion 54 toward one side in the circumferential direction Dr of the reactor main body M. The module lower portions 52 of the third and fifth blanket modules 51_3 and 51_5 protrude more than the flow path portion 54 toward the opposite side in the circumferential direction Dr of the reactor main body M. This structure can reduce the gap between two adjacent module assemblies 50A.

The helical coils 30 include the first coil upper-half 30a and the second coil upper-half 30a that are adjacent in the circumferential direction around the center line C1 along the vertical direction of the helical coils 30 and are positioned above the horizontal plane P1 passing through the center of the helical coils 30. The blanket 50 includes a plurality of module assemblies 50A disposed in the circumferential direction, and each of the module assemblies 50A includes a plurality of blanket modules 51. Each of the module assemblies 50A is configured such that a liquid breeding material flows from the upper side to the lower side inside the module assembly 50A. The first module assembly 50A, which is one of the plurality of module assemblies 50A, is disposed between the first coil upper-half 30a and the second coil upper-half 30a. The blanket modules 51 of the first module assembly 50A are combined with each other and form the discharge opening 55a at the lower end thereof.

The lower pool 62 is positioned below the discharge opening 55a. This structure facilitates the flow of liquid breeding material from the surface 52g of the module lower portion 52 to the lower pool 62. Further, for example, helium ash from the divertor plasma formed in the vicinity of the discharge opening 55a of the module lower portion 52 can be efficiently discharged to the lower pool 62 together with the liquid breeding material.

The helical coils 30 include two coil lower-halves 30b positioned below the horizontal plane P1 and adjacent to each other in the circumferential direction. The lower pool 62 is positioned between the two coil lower-halves 30b. In this structure, the distance between the module lower portion 52 and the lower pool 62 can be reduced.

It should be noted that the helical fusion reactor, the vacuum vessel of the helical fusion reactor, and the method for replacing the blanket proposed in the present disclosure are not limited to the examples described while referring to FIGS. 1 to 18.

In the example described above, the lower portion of the blanket module 51 (module lower portion 52) is disposed inside the helical coils 30, and the upper portion (module upper portion 53) is supported on the upper side of the upper wall 41 of the cryostat 40. However, the arrangement of the blanket modules 51 is not limited thereto, and for example, the entire blanket modules 51 may be disposed inside the helical coils 30.

What is claimed is:

1. A helical fusion reactor comprising:
a helical coil;
a blanket that is at least partially disposed inside the helical coil; and
a vacuum vessel that t houses the helical coil and the blanket, wherein
the blanket includes a plurality of module assemblies disposed in a circumferential direction around a center line along a vertical direction of the helical coil, each of the plurality of module assemblies including a plurality of blanket modules,
each blanket module is movable upward from a gap formed in the helical coil,
the vacuum vessel includes a movable cover that covers an upper side of the helical coil and the plurality of module assemblies, the movable cover being openable and closable, and
the movable cover is configured such that the whole movable cover moves integrally when the movable cover is opened and closed.

2. The helical fusion reactor according to claim 1, comprising a cryostat that houses the helical coil, wherein
the cryostat includes an upper wall that covers an upper side of the helical coil,
a plurality of openings are formed in the upper wall, positions of the plurality of openings respectively corresponding to positions of the plurality of module assemblies, and
the plurality of module assemblies are movable upward passing through the plurality of openings.

3. The helical fusion reactor according to claim 1, wherein
the movable cover covers the plurality of module assemblies over an entire circumference of the helical coil around the center line along the vertical direction and is configured such that the whole movable cover moves integrally when the movable cover is opened and closed.

4. The helical fusion reactor according to claim 1, wherein
the movable cover is supported via a hinge and is openable and closable around the hinge.

5. The helical fusion reactor according to claim 1, wherein
an outer peripheral edge of the movable cover is joined to a part of the vacuum vessel other than the movable cover, and
the helical fusion reactor further includes a release device that is movable along the outer peripheral edge of the movable cover and releases a joint between the outer peripheral edge of the movable cover and the part of the vacuum vessel.

6. The helical fusion reactor according to claim 1, wherein
the release device is movable substantially over the entire circumference of the helical coil around the center line along the vertical direction of the helical coil.

7. The helical fusion reactor according to claim 6, wherein
the vacuum vessel includes a guide that is formed along the outer peripheral edge of the movable cover, and
the release device is movable along the guide.

8. The helical fusion reactor according to claim 5, wherein
the outer peripheral edge of the movable cover is welded to a part of the vacuum vessel other than the movable cover, and
the release device cuts the welded part.

9. The helical fusion reactor according to claim 1, further comprising:
a storage chamber for the blanket module; and
a transport system that moves the blanket module to a position above the helical coil and moves the blanket module from the position above the helical coil to the storage chamber.

10. The helical fusion reactor according to claim 9, wherein
the transport system is configured to move a position of each blanket module in the circumferential direction.

11. The helical fusion reactor according to claim 9, wherein
the transport system is configured to tilt each blanket module with respect to the center line along the vertical direction of the helical coil.

12. The helical fusion reactor according to claim 1, wherein
each of the plurality of module assemblies is configured such that a liquid breeding material flows inside the module assembly from an upper side of the module assembly to a lower side thereof, and
a pipe is connected to the movable cover for supplying the liquid breeding material to the upper side of the plurality of module assemblies.

13. The helical fusion reactor according to claim 12, wherein
the pipe includes a joint pipe and a feed pipe, the joint pipe being fixed to the movable cover and moving integrally with the movable cover when the movable cover is opened and closed, the feed pipe connecting to the joint pipe and separable from the joint pipe.

14. The helical fusion reactor according to claim 13, wherein
an end of the joint pipe is positioned inside the outer peripheral edge of the movable cover, and
the feed pipe is separable from the joint pipe and movable toward the outside of the outer peripheral edge of the movable cover.

15. A vacuum vessel for housing a helical coil and a blanket of a helical fusion reactor, at least a part of blanket being disposed inside the helical coil, the blanket including a plurality of module assemblies disposed in a circumferential direction around a center line along a vertical direction of the helical coil, each of the plurality of module assemblies including a plurality of blanket modules, each blanket module being movable upward from a gap formed in the helical coil,
the vacuum vessel comprising a movable cover for covering an upper side of the helical coil and the plurality of module assemblies, the movable cover being openable and closable, and the movable cover being configured such that the whole movable cover moves integrally when the movable cover is opened and closed.

16. A method for maintaining a helical fusion reactor including a helical coil and a blanket, at least part of the blanket being disposed inside a helical coil, the helical coil and the blanket being housed in a vacuum vessel, the vacuum vessel including a movable cover that covers an upper side of the helical coil, and an outer peripheral edge of the movable cover is joined to a part of the vacuum vessel other than the movable cover, the method comprising:
moving a release device along the outer peripheral edge of the movable cover to release a joint between the outer peripheral edge of the movable cover and the part of the vacuum vessel;
opening the movable cover; and
pulling up a blanket module constituting the blanket from a gap formed in the helical coil by using a transport system.
